(19) United States
(12) Patent Application Publication
(10) Pub. No.: US 2026/0003668 A1
(43) Pub. Date: Jan. 1, 2026

(54) WORKLOAD MANAGEMENT ON AN ACCELERATION PROCESSOR

(71) Applicant: Advanced Micro Devices, Inc., Santa Clara, CA (US)

(72) Inventor: Nicholas James Goote, Hudsonville, MI (US)

(73) Assignee: Advanced Micro Devices, Inc., Santa Clara, CA (US)

(21) Appl. No.: 18/759,918

(22) Filed: Jun. 30, 2024

(51) Int. Cl. G06F 9/48; G06F 9/50; G06N 3/08

(52) U.S. Cl. CPC G06F 9/485; G06F 9/5005; G06N 3/08

(57) ABSTRACT

In accordance with the described techniques, a system includes a host processor and a control processor communicatively coupled to an acceleration processor. The control processor includes a management thread. The management thread receives requests to execute multiple workloads of multiple applications on the acceleration processor. Further, the management thread creates task threads on the control processor allocated to corresponding applications and corresponding partitions of the acceleration processor. The task threads receive the multiple workloads from the host processor, and dispatch the multiple workloads to corresponding partitions to be executed by the acceleration processor in parallel.

### BACKGROUND

Acceleration processors are specialized processors designed to enhance the performance of specific computational tasks. Typically, acceleration processors are implemented in a device or system (e.g., a system-on-a-chip) along with a central processing unit, e.g., CPU. Acceleration processors execute the specific computational tasks faster than the central processing unit. As such, the central processing unit offloads workloads to the acceleration processor that the acceleration processor is designed to execute. By leveraging the acceleration processor, a device or system executes these workloads faster, thereby increasing throughput, energy efficiency, and overall performance of the device or system.

### BRIEF DESCRIPTION OF THE DRAWINGS

FIG. 1 is a block diagram of a non-limiting example system to implement workload management on an acceleration processor.

FIG. 2 depicts a non-limiting example of memory allocation in accordance with workload management on an acceleration processor.

FIG. 3 depicts a non-limiting example of data movement within a non-limiting example system for workload management on an acceleration processor.

FIG. 4 depicts a procedure in an example implementation of workload management on an acceleration processor as implemented by a control processor.

FIG. 5 depicts a procedure in an example implementation of workload management on an acceleration processor as implemented by a host processor.

FIG. 6 is a block diagram of a processing system configured to execute one or more applications, in accordance with one or more implementations.

FIG. 7 is a block diagram of an accelerator unit (AU) configured to execute workloads for applications running on a processing system, in accordance with one or more implementations.

### DETAILED DESCRIPTION

### Overview

A device includes a host processor, and a control processor communicatively coupled to an acceleration unit. The host processor includes applications running on the host processor, as well as a host driver to translate application code into machine-readable code that is executable by the acceleration unit. Furthermore, the control processor is configured to run coordination firmware that manages communications between the host driver and the acceleration processor. The acceleration unit includes multiple partitions capable of executing multiple workloads in parallel. Moreover, the control processor and the host processor are connected via interconnect circuitry.

In accordance with the described techniques, the applications submit requests to the host driver requesting to execute workloads on the acceleration processor to the host driver. The host driver communicates the requests to a management thread of the coordination firmware via the interconnect circuitry. Based on the requests, the management thread allocates one or more partitions of the acceleration processor to each of the applications, and creates a task thread for each of the applications.

To create a task thread for an application, the management thread allocates a first address space in control memory (e.g., local memory of the control processor) to the task thread. Furthermore, the management thread communicates the first address space to the host driver via the interconnect circuitry. In response, the host driver allocates a second address space in interconnect memory to the application, and maps the second address space to the first address space. For instance, the first address space and the second address space are connected via the interconnect circuitry. This opens up a communication channel enabling direct communication of data between the host driver and the task thread for the application. For example, the host driver communicates with the task thread by writing data to the second address space, while the task thread communicates with the host driver by writing data to the first address space. This process is repeated for a plurality of task threads, e.g., opening a communication channel between the host driver and a task thread for each of the applications.

Accordingly, the applications submit workloads to the host driver, which communicates the workloads to corresponding task threads via the communication channels. Further, the task threads communicate the workloads to corresponding partitions to be executed in parallel by the acceleration unit.

The described techniques, therefore, enable increased utilization of the acceleration processor, as compared to conventional techniques. This is, in part, because many applications execute workloads on different partitions of the acceleration unit in parallel. The described techniques also reduce communication latency and communication overhead for communications between the host driver and the control processor. This is, in part, because the different threads communicate with the host driver concurrently via the opened communication channels. By reducing the communication overhead and latency of these communications, the described techniques fill partitions of the acceleration processor with workloads faster, which further increases utilization of the acceleration processor. Moreover, the different threads operate in isolated memory spaces, which prevents applications from accessing data of other applications. In summary, the described techniques enable different applications to execute workloads on the acceleration processor in parallel, in a secure manner, while increasing acceleration processor utilization.

In some aspects, the techniques described herein relate to a system comprising a host processor, and a control processor communicatively coupled to an acceleration processor, the control processor configured to receive, from the host processor and via a management thread of the control processor, requests to execute multiple workloads of multiple applications on the acceleration processor, create, by the management thread, task threads on the control processor allocated to corresponding applications and corresponding partitions of the acceleration processor, receive, via the task threads, the multiple workloads from the host processor, and dispatch, by the task threads, the multiple workloads to the corresponding partitions to be executed by the acceleration processor in parallel.

In some aspects, the techniques described herein relate to a system, wherein to create the task threads, the control processor is configured to allocate, by the management thread, address spaces of control memory of the control processor to the corresponding applications.

In some aspects, the techniques described herein relate to a system, wherein the control processor is configured to isolate, via the management thread and using memory isolation techniques, the address spaces in the control memory, thereby making data of the multiple applications inaccessible by other applications.

In some aspects, the techniques described herein relate to a system, wherein to create a task thread for an application, the control processor is configured to open, via the management thread, a communication channel between the application and the task thread.

In some aspects, the techniques described herein relate to a system, wherein to open the communication channel, the control processor is configured to communicate, via the management thread, a first address space of the control memory allocated to the task thread, the first address space being mapped to a second address space of interconnect memory accessible by the host processor.

In some aspects, the techniques described herein relate to a system, wherein the communication channel includes interconnect circuitry that transports data written to the first address space by the control processor to the second address space, and transports data written to the second address space by the host processor to the first address space.

In some aspects, the techniques described herein relate to a system, wherein the communication channel is a bi-directional communication channel in which the first address space includes a first write portion and a first read portion, the second address space includes a second write portion and a second read portion, the first read portion is connected via the interconnect circuitry to the second write portion, and the second read portion is connected via the interconnect circuitry to the first write portion.

In some aspects, the techniques described herein relate to a system, wherein the bi-directional communication channel enables bi-directional, simultaneous communication of data between the control processor and the host processor.

In some aspects, the techniques described herein relate to a system, wherein the acceleration processor is a neural processor configured to accelerate execution of machine learning workloads, and the multiple workloads include trained machine learning models and instructions for executing data, using the trained machine learning models, on the corresponding partitions of the neural processor.

In some aspects, the techniques described herein relate to a system, wherein the control processor is further configured to communicate, via a task thread of an application, a completion signal to the host processor indicating that a workload has completed, the completion signal instructing the host processor to send an additional workload or send a closure signal to close the task thread.

In some aspects, the techniques described herein relate to a device comprising a control processor communicatively coupled to an acceleration processor, and a host processor to communicate, to a management thread of the control processor, requests to execute multiple workloads of multiple applications on the acceleration processor, receive indications of task threads of the control processor allocated to corresponding applications and corresponding partitions of the acceleration processor, the indications representing communication channels between the task threads and the corresponding applications, and communicate, via the communication channels, the multiple workloads of the corresponding applications to the task threads to be forwarded to the corresponding partitions for parallel execution.

In some aspects, the techniques described herein relate to a device, wherein to receive an indication of a task thread allocated to an application, the host processor is configured to receive a first address space of control memory of the control processor allocated to the task thread, and allocate a second address space of interconnect memory accessible by the host processor to the application, the second address space being mapped to the first address space.

In some aspects, the techniques described herein relate to a device, wherein a communication channel between the task thread and the application includes interconnect circuitry that transports data written to the first address space by the control processor to the second address space, and transports data written to the second address space by the host processor to the first address space.

In some aspects, the techniques described herein relate to a device, wherein the communication channel is a bi-directional communication channel in which first address space includes a first write portion and first read portion, the second address space includes a second write portion and a second read portion, the first read portion is connected via the interconnect circuitry to the second write portion, and the second read portion is connected via the interconnect circuitry to the first write portion.

In some aspects, the techniques described herein relate to a device, wherein the bi-directional communication channel enables bi-directional, simultaneous communication of data between the control processor and the host processor.

In some aspects, the techniques described herein relate to a device, wherein the acceleration processor is a neural processor configured to accelerate execution of machine learning workloads, and the multiple workloads include trained machine learning models and instructions for executing data, using the trained machine learning models, on the corresponding partitions of the neural processor.

In some aspects, the techniques described herein relate to a device, wherein the host processor is further configured to receive, from a task thread of an application, a completion signal indicating that a workload has completed, and communicate, to the task thread and in response to the completion signal, an additional workload or a closure signal to close the task thread.

In some aspects, the techniques described herein relate to a method comprising receiving, by a management thread of a control processor, requests to execute multiple workloads of multiple applications on an acceleration processor, creating, by the management thread, task threads on the control processor allocated to corresponding applications and corresponding partitions of the acceleration processor, the management thread and the task threads operating in isolated memory spaces, and forwarding, by the task threads, workloads received from the corresponding applications to the corresponding partitions to be executed by the acceleration processor in parallel.

In some aspects, the techniques described herein relate to a method, wherein creating the task threads includes allocating, by the management thread, address spaces of control memory of the control processor to the corresponding applications, and isolating, by the management thread and using memory isolation techniques, the address spaces in the control memory, thereby making data of the multiple applications inaccessible by other applications.

In some aspects, the techniques described herein relate to a method, wherein creating the task threads includes opening communication channels between the task threads and the corresponding applications, the communication channels including interconnect circuitry connecting first address spaces of the task threads to second address spaces accessible by the corresponding applications.

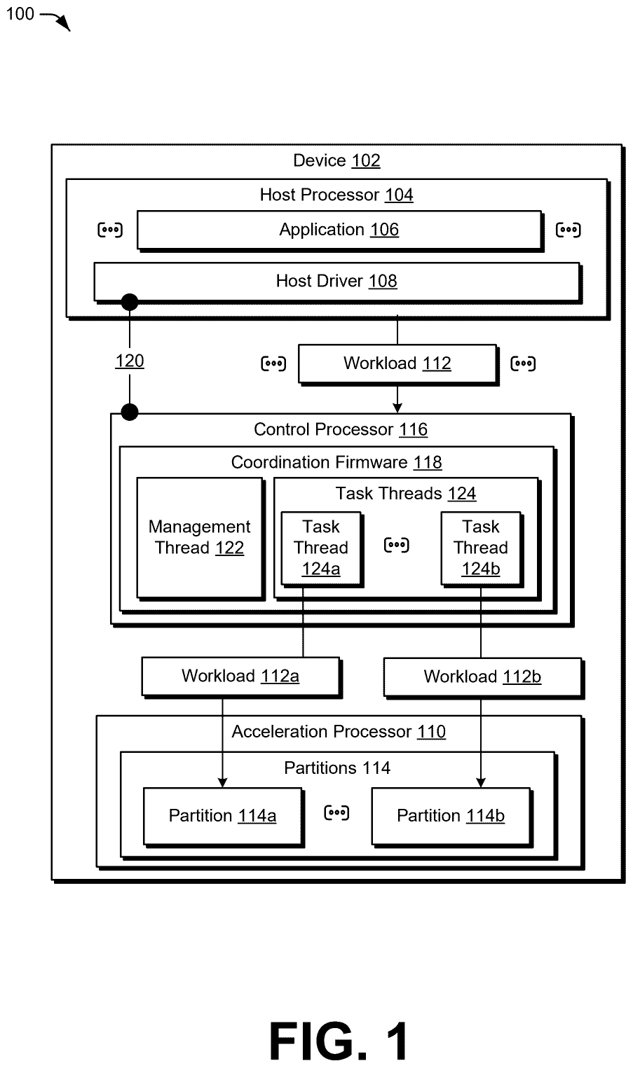

FIG. 1 is a block diagram of a non-limiting example system 100 to implement configurable and scalable power gating. The system includes a device 102, examples of which include, by way of example and not limitation, computing devices, servers, mobile devices (e.g., wearables, mobile phones, tablets, laptops), processors (e.g., graphics processing units, central processing units, and accelerators), digital signal processors, interference accelerators, disk array controllers, hard disk drive host adapters, memory cards, solid-state drives, wireless communications hardware connections, Ethernet hardware connections, switches, bridges, network interface controllers, mobile phones, tablets and other apparatus configurations. It is to be appreciated that in various implementations, the techniques described herein are implementable using any one or more of those devices listed just above and/or a variety of other devices without departing from the spirit or scope of the described techniques.

The illustrated device 102 further includes a host processor 104, which is an electronic circuit configured to run applications 106. By way of example, the host processor 104 includes an operating system (not shown) that manages execution of the applications 106. For instance, the applications 106 correspond to software programs having executable instructions, and the operating system schedules the execution of those instructions, e.g., on the host processor 104 or connected processors in a multi-processor system. In various examples, the host processor 104 includes one or more processor cores. Examples of the host processor 104 and/or the one or more cores include, but are not limited to including, a central processing unit (CPU), a field programmable gate array (FPGA), and an application specific integrated circuit (ASIC).

The host processor 104 further includes a host driver 108, which is a software program running on the host processor 104 to enable the applications 106 and/or the operating system to communicate with an external hardware device, e.g., an acceleration processor 110. For example, the applications 106 submit instructions to the host driver 108, which translates the instructions written in high-level source programming languages to low-level hardware instructions that are executable by the acceleration processor 110. Thus, instructions submitted by an application 106 to the acceleration processor 110, as discussed herein, are first submitted to the host driver 108, and then passed along to the acceleration processor 110 by the host driver 108.

The acceleration processor 110 is an electronic circuit designed to execute specific types of workloads 112 faster than the host processor 104. By way of example, the acceleration processor 110 is a neural processing unit (e.g., an inference processor and/or an artificial intelligence engine (AIE)) designed to execute machine learning workloads 112 faster than the host processor 104. The described techniques, however, are implementable using any one or more of a variety of acceleration processors 110 including but not limited to, graphics processing units (GPUs), digital signal processors (DSPs), field-programmable gate arrays (FGPAs), video processing units (VPUs), and the like. The workloads 112 to be executed by the acceleration processor 110 include data and/or instructions submitted by the applications 106, and propagated to the acceleration processor 110 by the host driver 108, e.g., for the submitted data to be executed in accordance with the submitted instructions.

As shown, the acceleration processor 110 is organized into partitions 114. By way of example, the acceleration processor 110 is organized into arrays of compute units arranged into columns, and each of the compute units include processing resources, memory resources, and/or interconnect circuitry facilitating communication of data between the compute units. In this way, partitions 114 are formable as one or more columns of compute units dedicated to a particular process or function. In various examples of workload management on an acceleration processor, the partitions 114 are dedicated to executing workloads 112 of a particular application 106, e.g., the partitions 114 are allocated to respective applications 106. Different partitions 114 are capable of executing the workloads 112 independently and in parallel.

The device 102 is further illustrated as including a control processor 116, which is an electronic circuit that runs coordination firmware 118. The coordination firmware 118, for instance, is a program embedded on the control processor 116 that performs various tasks for coordinating communication between the host driver 108 and the acceleration processor 110 and allocating partitions 114 of the acceleration processor 110 to respective applications 106. Although implemented as a separate entity from the acceleration processor 110, it is to be appreciated that the control processor 116 is a component of the acceleration processor 110. In one or more implementations, the control processor 116 and the acceleration processor are communicatively coupled via wired or wireless connections, e.g., data buses.

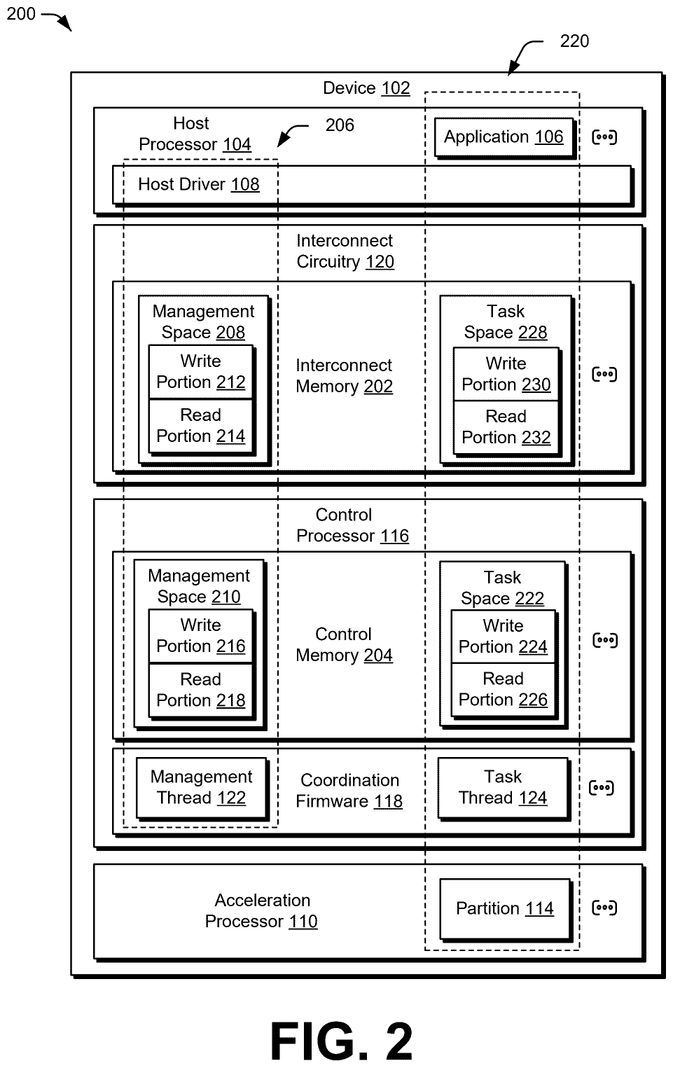

To facilitate this communication, interconnect circuitry 120 connects the host driver 108 and the control processor 116, as shown. As further discussed below with reference to FIG. 2, for instance, the interconnect circuitry 120 includes interconnect memory connected in circuitry to control memory of the control processor 116. More specifically, the interconnect circuitry 120 includes interconnect memory regions mapped to control memory regions, such that data written to the interconnect memory regions is transported via the interconnect circuitry 120 to corresponding control memory regions, and vice versa. In one non-limiting example, the interconnect circuitry 120 includes a peripheral component interconnect express (PCIe) device and the interconnect memory includes one or more PCIe base address registers (e.g., PCIe BAR), and PCIe data buses.

In accordance with the described techniques, the coordination firmware 118 includes a management thread 122 and multiple task threads 124. The threads 122, 124 represent isolated contexts of execution running on the control processor 116 and/or the coordination firmware 118. For example, the threads 122, 124 are managed independently by the coordination firmware 118 to run on one or more processor cores of the control processor 116. In various examples, two or more threads 122, 124 execute in parallel and/or concurrently using multi-threading techniques. Furthermore, the threads 122, 124 share the control memory (e.g., a non-volatile memory of the control processor 116, such as a static random-access memory (SRAM)), but operate in isolated address spaces. By way of example, the coordination firmware 118 uses memory isolation techniques (e.g., process address space identity (PASID)) to allocate a distinct and separate process address space in the control memory to each thread 122, 124.

In particular, after the device 102 is powered up but before the acceleration processor 110 is invoked to execute a workload 112, the control processor 116 includes the management thread 122, but not the task threads 124. Broadly, the management thread 122 is configured to create the task threads 124 for different applications 106, so that the different applications 106 can submit workloads 112 to corresponding task threads 124 for execution on the acceleration processor 110.

As part of this, the applications 106 submit, via the host driver 108, requests to execute workloads 112 on the acceleration processor 110. The requests are communicated using the interconnect circuitry 120, and received by the management thread 122. Based on the requests, the management thread 122 opens a task thread 124 for each application 106 that submitted requests. Opening a task thread 124 for an application 106 includes allocating an address space in the control memory to the application and opening a direct communication channel (e.g., in the interconnect circuitry 120) between the host driver 108 and the task thread 124 for the application 106. In addition, the management thread 122 allocates one or more partitions 114 to each application 106 that submitted requests. In the illustrated example, for instance, the management thread 122 opens a first task thread 124a for a first application 106, and a second task thread 124b for a second application 106. Furthermore, the management thread 122 allocates a first partition 114a to the first application 106, and allocates a second partition 114b to the second application 106.

The task threads 124 are configured to receive workloads 112 of the applications 106 to which the task threads 124 are assigned, and dispatch the workloads 112 to the corresponding partitions 114 to be executed in parallel. By way of example, the first application 106 submits a workload 112a to the host driver 108, and the host driver 108 communicates the workload 112a to the first task thread 124a via the interconnect circuitry 120. In particular, the host driver 108 communicates the workload 112 via the direct communication channel established between the task thread 124a and the host driver 108 for the first application 106. As shown, the task thread 124a dispatches the workload 112a to the partition 114a to be executed.

Similarly, the second application 106 submits a workload 112b to the host driver 108, and the host driver 108 communicates the workload 112b to the second task thread 124b via the interconnect circuitry 120. In particular, the host driver 108 communicates the workload 112b via the direct communication channel established between the task thread 124b and the host driver 108 for the second application 106. As shown, the task thread 124b dispatches the workload 112b to the partition 114b to be executed. In various implementations, the workloads 112a, 112b are executed by the partitions 114a, 114b in parallel. Although the above example is described in the context of two applications 106 assigned to two corresponding task threads 124a, 124b and allocated two corresponding partitions 114b, it is to be appreciated that the described techniques are extendable to any number of applications 106 assigned to any number of task threads 124 and allocated any number of partitions 114 of the acceleration processor 110.

FIG. 2 depicts a non-limiting example 200 of memory allocation in accordance with workload management on an acceleration processor. In the example 200, the device 102 includes interconnect memory 202 (e.g., PCIe BARs) of the interconnect circuitry 120 and control memory 204 (e.g., local SRAM) of the control processor 116. During an initial cold boot sequence for the control processor 116, a communication channel 206 is established between the host driver 108 and the management thread 122.

As part of this, a management space 208 of the interconnect memory 202 is connected to a management space 210 of the control memory 204 via the interconnect circuitry 120. By way of example, the management spaces 208, 210 represent memory address ranges within the interconnect memory 202 and the control memory 204, respectively. More specifically, the management space 208 of the interconnect memory 202 includes a write portion 212 and a read portion 214 (e.g., sub-ranges of memory addresses within the management space 208), while the management space 210 of the control memory 204 includes a write portion 216 and a read portion 218, e.g., sub-ranges of memory addresses within the management space 208. The write portion 216 of the management space 210 in control memory 204 is connected via the interconnect circuitry 120 to the read portion 214 of the management space 208 in interconnect memory 202. Similarly, the read portion 218 of the management space 210 in control memory 204 is connected via the interconnect circuitry 120 to the write portion 212 of the management space 208 in interconnect memory 202.

Thus, when the management thread 122 writes data to the write portion 216 of the management space 210 in control memory 204, the interconnect circuitry 120 transports the written data to the read portion 214 of the management space 208 in interconnect memory 202. The host driver 108 then reads this data from the read portion 214. Similarly, when the host driver 108 writes data to the write portion 212 of the management space 208 in interconnect memory 202, the interconnect circuitry 120 transports the written data to the read portion 218 of the management space 210 in control memory 204. The management thread 122 then reads this data.

In other words, the communication channel 206 is a bi-directional communication channel enabling bi-directional, simultaneous communication of data between the host driver 108 and the management thread 122. For example, the host driver 108 communicates data to the management thread 122 via the communication channel 206 and the management thread 122 communicates data to the host driver 108 via the communication channel 206 in parallel. Moreover, the management thread 122 reads and writes to the management space 210 concurrently or in parallel, while the host driver reads and writes to the management space 208 concurrently or in parallel.

This process of establishing a management thread 122 on the coordination firmware 118 and establishing a communication channel 206 between the management thread 122 and the host driver 108 is part of an initialization process for the control processor 116 in one or more implementations. The establishment of the communication channel 206 enables the applications 106 to submit the requests to the management thread 122. As previously mentioned, the requests are to execute workloads 112 on the acceleration processor 110. By way of example, the host driver 108 receives the requests from the applications 106, writes the requests to the write portion 212, and the interconnect circuitry 120 transports the requests to the read portion 218. The management thread 122 reads the requests from the read portion 218, and in response, initiates a process for creating the task threads 124 and opening communication channels 220 between the task threads 124 and the host driver 108.

For example, the management thread 122 reads, from the read portion 218, a request associated with an application 106 to execute a workload 112 on the acceleration processor 110. In response, the management thread 122 establishes a task thread 124 for the application 106, and allocates a partition 114 to the application 106. Furthermore, the management thread 122 allocates a task space 222 (e.g., a memory address range) of control memory 204 to the task thread 124, and the task space 222 includes a write portion 224 and a read portion 226 (e.g., memory address sub-ranges) within the task space 222. Given this, the management thread 122 writes an indication of the task space 222 (e.g., including the write portion 224 and the read portion 226) to the write portion 216 of the management space 210.

The indication of the task space 222 is communicated via the interconnect circuitry 120 to the read portion 214 of the management space 208 in interconnect memory 202. Accordingly, the host driver 108 reads the indication of the task space 222 from the read portion 214 and allocates a corresponding task space 228 (e.g., a memory address range) of interconnect memory 202 to the first application 106, and the task space 228 includes a write portion 230 and a read portion 232 (e.g., memory address sub-ranges) within the task space 228. Here, the write portion 224 of the task space 222 in control memory 204 is connected via the interconnect circuitry 120 to the read portion 232 of the task space 228 in interconnect memory 202. Similarly, the read portion 226 in the task space 222 of control memory 204 is connected via the interconnect circuitry 120 to the write portion 230 of the task space 228 in interconnect memory 202.

Thus, when the task thread 124 writes data to the write portion 224 of the task space 222 in control memory 204, the interconnect circuitry 120 transports the written data to the read portion 232 of the task space 228 in interconnect memory 202. The host driver 108 then reads this data from the read portion 232. Similarly, when the host driver 108 writes data to the write portion 230 of the task space 228 in interconnect memory 202, the interconnect circuitry 120 transports the written data to the read portion 226 of the task space 222 in control memory 204.

Thus, the communication channel 220 is a bi-directional communication channel enabling bi-directional, simultaneous communication of data between the host driver 108 and the task thread 124. For example, the host driver 108 communicates data to the task thread 124 via the communication channel 220 and the task thread 124 communicates data to the host driver 108 via the communication channel 220 in parallel. Moreover, task thread 124 reads and writes to the task space 222 concurrently or in parallel, while the host driver 108 reads and writes to the task space 228 concurrently or in parallel.

Once the communication channel 220 is established, the application 106 submits the workload 112 to the host driver 108, and the host driver 108 writes the workload 112 to the write portion 230. Furthermore, the interconnect circuitry 120 transports the workload 112 to the read portion 226, and the task thread 124 dispatches the workload 112 from the read portion 226 to be executed by the partition 114. As mentioned above, communication channels 220 are created for any number of task thread 124, partition 114, and application 106 groupings. As such, different workloads 112 of different applications 106 are executed by different partitions 114 in parallel.

Once the workload 112 finishing executing on the partition 114, the task thread 124 communicates a communication signal to the host driver 108, which notifies the application 106 of completion of the workload 112. If the application 106 has more workloads 112 to be executed on the acceleration processor 110, the application 106 communicates an additional workload 112 to the task thread 124 via the communication channel 220.

If, however, there are no more workloads 112 of the application 106 to be executed on the acceleration processor 110, application 106 communicates a closure signal to the task thread 124 via the communication channel 220. In response, the coordination firmware 118 closes the task thread 124, leaving the partition 114 unallocated to an application 106. In various scenarios, the read portion 218 of the management space 210 represents a queue of pending requests to execute workloads 112 on the acceleration processor 110 from different applications 106. Thus, after the task thread 124 is closed, the management thread 122 obtains a request associated with a different application 106 from the read portion 218, allocates the partition 114 to the different application 106, and creates a new task thread 124 for the different application 106.

As discussed, the management thread 122 is responsible for allocating task spaces 222 to task threads 124. To enable the allocation of task spaces 222 (e.g., process address spaces), the management thread 122 runs at a higher privilege level than the task threads 124 in various implementations. Furthermore, as previously mentioned, the coordination firmware 118 uses memory isolation techniques to allocate a distinct and separate task space 222 in the control memory 204 to each thread 122, 124. This involves assigning each thread a corresponding process address space identifier, e.g., a unique PASID.

Given the above, the described techniques enable increased acceleration processor 110 utilization, as compared to conventional techniques. This is because the coordination firmware 118 enables many applications 106 to run their workloads 112 on different partitions 114 in parallel. Furthermore, the described techniques reduce communication overhead and communication latency. This is because the different threads 122, 124 communicate with the host driver 108 concurrently, the host driver 108 and the threads 122, 124 read and write to the communication channels 206, 220 concurrently, and the communication channels 206, 220 each enable bi-directional, simultaneous communication of data between the threads 122, 124 and the host processor 104. By reducing the communication overhead and latency of these communications, the described techniques fill the partitions 114 with workloads faster, which further improves acceleration processor 110 utilization. Finally, the coordination firmware 118 forms independent execution environments for the different threads 122, 124 and applications 106. This enables many applications 106 to run their workloads on different partitions 114 of the acceleration processor 110 concurrently without data leakage between applications 106.

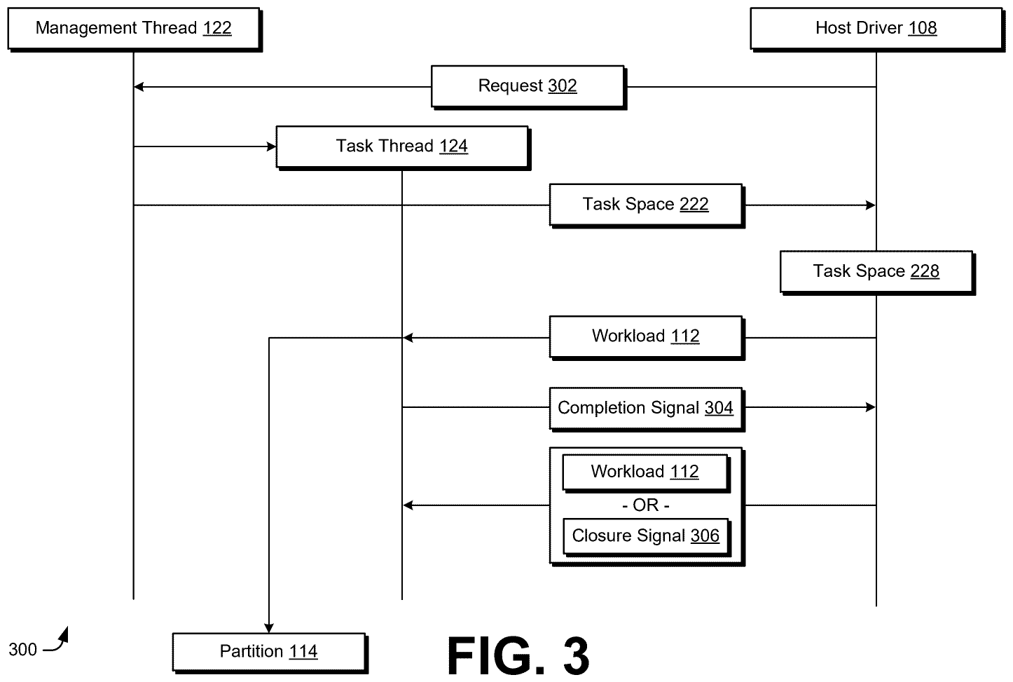

FIG. 3 depicts a non-limiting example 300 of data movement within a non-limiting example system for workload management on an acceleration processor. In the example 300, the host driver 108 communicates a request 302 of an application 106 to execute one or more workloads 112 on the acceleration processor 110 to the management thread 122. The request is communicated to the management thread 122 via the communication channel 206. In one or more implementations, the request 302 includes one or more partitions 114 on which to execute the one or more workloads 112. Based on the request 302, the management thread 122 creates a task thread 124 and allocates a partition 114 (e.g., the partition 114 specified by the request 302) to the application 106. Furthermore, the management thread 122 allocates a task space 222 in control memory 204 to the task thread 124, in accordance with the techniques discussed below with reference to FIG. 2. The management thread further communicates an indication of the task space 222 in control memory 204 to the host driver 108 via the communication channel 206.

In response, the host driver 108 allocates a task space 228 in interconnect memory 202 to the application 106. This opens up the communication channel 220 between the application 106 and the task thread 124. After the communication channel 220 is opened, the application 106 submits the workload 112 to the host driver 108, which communicates the workload 112 to the task thread 124 via the communication channel 220.

The workload 112 includes data, as well as instructions for executing the data. The workload 112, in various examples, includes instructions to be executed by the control processor 116 and/or the acceleration processor 110. By way of example, the instructions of the workload 112 instruct the task thread 124 how to access data from main memory and how to load the data into the acceleration processor 110, e.g., into the compute units. Additionally or alternatively, the instructions include specific operations to be performed by the acceleration processor 110 on the loaded data. In at least one example in which the acceleration processor 110 is a neural processing unit, the workload 112 is a machine learning workload including data and instructions for executing the data using a trained machine learning model on the partition 114 of the acceleration processor 110.

As shown, the task thread 124 receives the workload 112 and dispatches the workload 112 to be executed on the partition 114 of the acceleration processor 110. In the example in which the acceleration processor 110 is a neural processing unit, the task thread 124 loads data of the workload 112 into the partition 114 in accordance with the instructions of the workload 112. Further, the partition 114 of the acceleration processor 110 executes a trained machine learning model on the loaded data by executing the instructions of the workload 112.

Once the workload 112 finishes executing, the task thread 124 communicates a completion signal 304 to the host driver 108 via the communication channel 220. The host driver 108 notifies the application 106 of the completion of the workload 112. In response, the application 106 communicates an additional workload 112 to the task thread 124 via the communication channel 220, in various scenarios. In such scenarios, the task thread 124 dispatches the additional workload 112 to be executed on the partition 114, in accordance with the described techniques.

Alternatively, the host driver 108 communicates a closure signal 306 to the task thread 124 via the communication channel 220. In response to receiving the closure signal 306, the task thread closes the task thread 124, leaving the partition 114 unallocated. Thus, the management thread 122 checks the read portion 218 of the management space 210 in control memory 204 for enqueued requests to execute workloads 112 on the acceleration processor 110. If such a request of an additional application 106 is enqueued, the management thread 122 generates a new task thread 124 and allocates the partition 114 to the new task thread 124. Further, the process shown in the example 300 is repeated for a new application 106 associated with the enqueued request.

Although the example 300 is shown with respect to just one task thread 124 allocated to one application 106. It is to be appreciated that similar processes are happening concurrently with respect to a plurality of task threads 124 allocated to a plurality of applications 106.

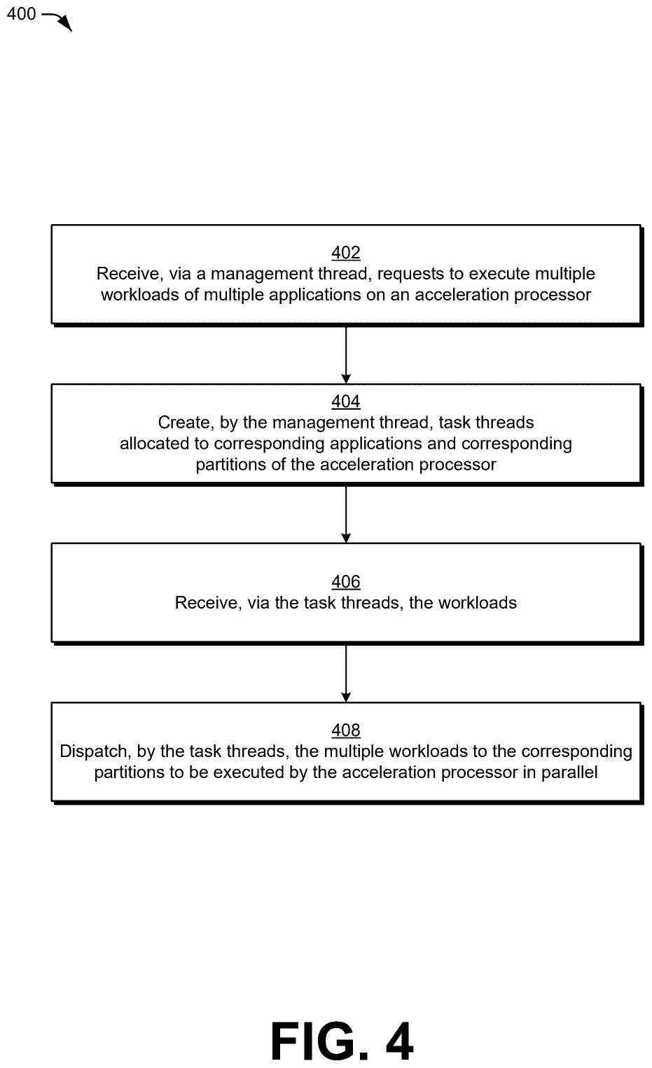

FIG. 4 depicts a procedure 400 in an example implementation of workload management on an acceleration processor as implemented by a control processor. In the procedure 400, requests are received via a management thread to execute multiple workloads of multiple applications on an acceleration processor (block 402). For example, the management thread 122 receives requests 302, via the bi-directional communication channel 206 to execute workloads 112 on the acceleration processor 110. The requests 302 are received from multiple applications 106.

Task threads are created, and the task threads are allocated to corresponding applications and corresponding partitions on the acceleration processor (block 404). By way of example, the management thread 122 creates a task thread 124 for each of the multiple applications 106, and allocates one or more partitions 114 to each of the multiple applications 106. Furthermore, the management thread 122 opens a bi-directional communication channel 220 between the application 106 and the task thread 124 for each of the multiple applications 106

The workloads are received via the task threads (block 406). For instance, each of the task threads 124 receive workloads 112 of corresponding applications 106 via corresponding bi-directional communication channels 220.

The multiple workloads are dispatched by the task threads to the corresponding partitions to be executed by the acceleration processor in parallel (block 408). By way of example, the task threads 124 dispatch the workloads 112 to corresponding partitions 114 to which the task threads 124 are allocated. The dispatching of the workloads 112 occurs in parallel across different partitions 114, and the workloads 112 are executed by different partitions 114 in parallel.

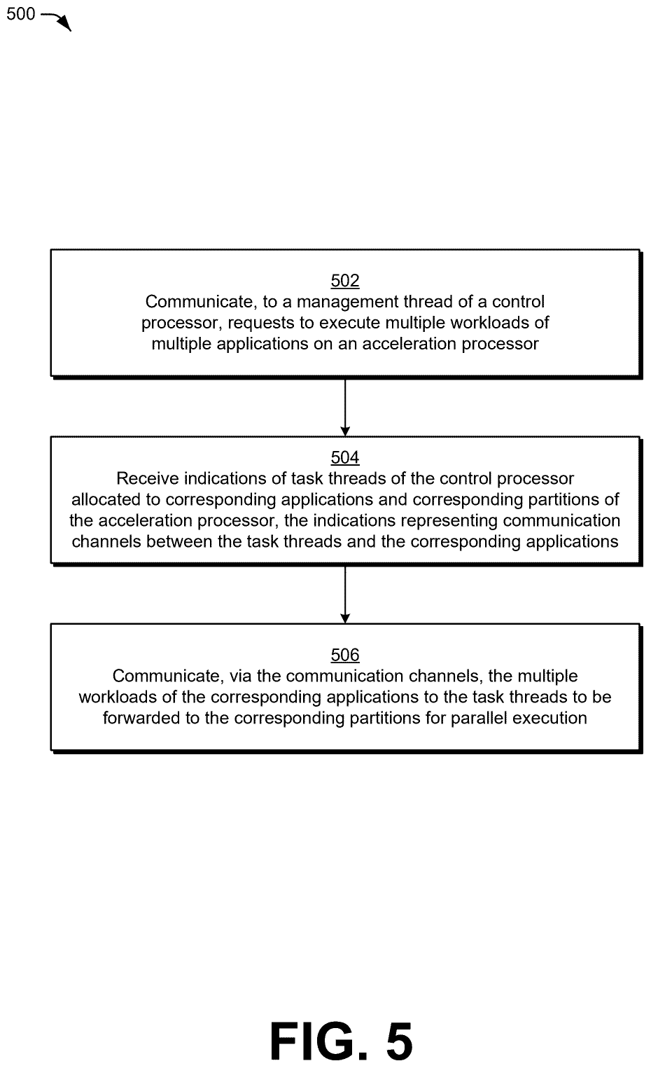

FIG. 5 depicts a procedure 500 in an example implementation of workload management on an acceleration processor as implemented by a host processor. In the procedure 500, requests to execute multiple workloads of multiple applications on an acceleration processor are communicated to a management thread of a control processor (block 502). For example, the host driver 108 communicates requests 302, via the bi-directional communication channel 206 to execute workloads on the acceleration processor 110. The requests 302 are submitted to the host driver 108 by multiple applications 106.

Indications are received of task threads of the control processor allocated to corresponding applications and corresponding partitions of the acceleration processor, the indications representing communication channels between the task threads and the corresponding applications (block 504). By way of example, the host driver 108 receives, via the communication channel 206, indications of task spaces 222 in control memory 204 allocated to respective task threads 124 and respective applications 106. Given a task space 222 in control memory 204 allocated to a corresponding task thread 124 and a corresponding application 106, the host driver 108 allocates a task space 228 in interconnect memory 202 to the corresponding application 106 that connects the task spaces 222, 228. This process is repeated for each task thread 124, thereby forming bi-directional communication channels 220 between the applications 106 and corresponding task threads 124.

The multiple workloads of the corresponding applications are communicated via the communication channels to the task threads to be forwarded to the corresponding partitions for parallel execution (block 506). By way of example, the host driver 108 communicates the workloads 112 of the applications 106 to corresponding task threads 124 via the corresponding b-directional communication channels 220. Further, the task threads 124 dispatch the workloads 112 to corresponding partitions 114 to be executed in parallel.

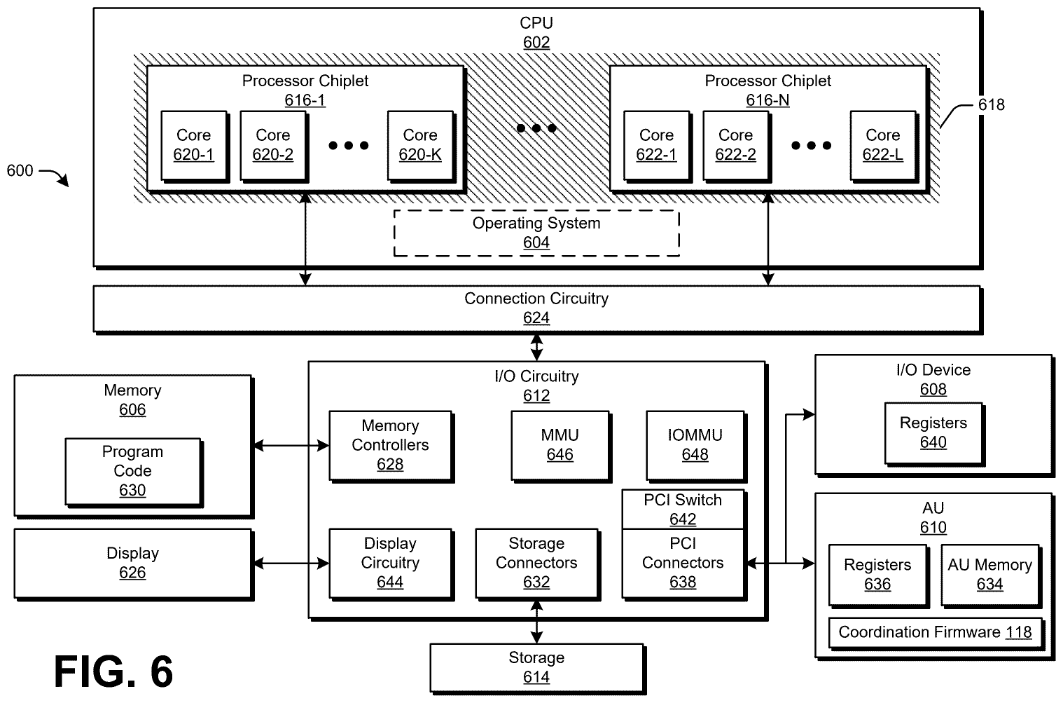

FIG. 6 includes a processing system 600 configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 600 includes a central processing unit (CPU) 602. In one or more implementations, the CPU 602 is configured to run an operating system (OS) 604 that manages the execution of applications. For example, the OS 604 is configured to schedule the execution of tasks (e.g., instructions) for applications, allocate portions of resources (e.g., system memory 606, CPU 602, input/output (I/O) device 608, accelerator unit (AU) 610, storage 614) for the execution of tasks for the applications, provide an interface to I/O devices (e.g., I/O device 608) for the applications, or any combination thereof.

In this example, the coordination firmware 118 is depicted in the AU 610. In variations, however, the coordination firmware 118 included in and/or is implemented by one or more different components of the processing system 600, such as the CPU 602, the memory 606, the I/O device 608, the I/O circuitry 612, the storage 614, and so forth. In at least one implementation, the coordination firmware 118 or portions of the coordination firmware 118 are included in at least two of the depicted components of the processing system 600. By way of example, the coordination firmware 118 may be included in or otherwise implemented by at least portions of the AU 610 and the I/O circuitry 612.

The CPU 602 includes one or more processor chiplets 616, which are communicatively coupled together by a data fabric 618 in one or more implementations. Each of the processor chiplets 616, for example, includes one or more processor cores 620, 622 configured to concurrently execute one or more series of instructions, also referred to herein as “threads,” for an application. Further, the data fabric 618 communicatively couples each processor chiplet 616-N of the CPU 602 such that each processor core (e.g., processor cores 620) of a first processor chiplet (e.g., 616-1) is communicatively coupled to each processor core (e.g., processor cores 622) of one or more other processor chiplets 616. Though the example embodiment presented in FIG. 6 shows a first processor chiplet (616-1) having three processor cores (620-1, 620-2, 620-K) representing a K number of processor cores 622 and a second processor chiplet (616-N) having three processor cores (e.g., 622-1, 622-2, 622-L) representing an L number of processor cores 622, in other implementations (L being an integer number greater than or equal to one), each processor chiplet 616 may have any number of processor cores 620, 622. For example, each processor chiplet 616 can have the same number of processor cores 620, 622 as one or more other processor chiplets 616, a different number of processor cores 620, 622 as one or more other processor chiplets 616, or both.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

Additionally, within the processing system 600, the CPU 602 is communicatively coupled to an I/O circuitry 612 by a connection circuitry 624. For example, each processor chiplet 616 of the CPU 602 is communicatively coupled to the I/O circuitry 612 by the connection circuitry 624. The connection circuitry 624 includes, for example, one or more data fabrics, buses, buffers, queues, and the like. The I/O circuitry 612 is configured to facilitate communications between two or more components of the processing system 600 such as between the CPU 602, system memory 606, display 626, universal serial bus (USB) devices, peripheral component interconnect (PCI) devices (e.g., I/O device 608, AU 610), storage 614, and the like.

As an example, system memory 606 includes any combination of one or more volatile memories and/or one or more non-volatile memories, examples of which include dynamic random-access memory (DRAM), static random-access memory (SRAM), non-volatile RAM, and the like. To manage access to the system memory 606 by CPU 602, the I/O device 608, the AU 610, and/or any other components, the I/O circuitry 612 includes one or more memory controllers 628. These memory controllers 628, for example, include circuitry configured to manage and fulfill memory access requests issued from the CPU 602, the I/O device 608, the AU 610, or any combination thereof. Examples of such requests include read requests, write requests, fetch requests, pre-fetch requests, or any combination thereof. That is to say, these memory controllers 628 are configured to manage access to the data stored at one or more memory addresses within the system memory 606, such as by CPU 602, the I/O device 608, and/or the AU 610.

When an application is to be executed by processing system 600, the OS 604 running on the CPU 602 is configured to load at least a portion of program code 630 (e.g., an executable file) associated with the application from, for example, a storage 614 into system memory 606. This storage 614, for example, includes a non-volatile storage such as a flash memory, solid-state memory, hard disk, optical disc, or the like configured to store program code 630 for one or more applications.

To facilitate communication between the storage 614 and other components of processing system 600, the I/O circuitry 612 includes one or more storage connectors 632 (e.g., universal serial bus (USB) connectors, serial AT attachment (SATA) connectors, PCI Express (PCIe) connectors) configured to communicatively couple storage 614 to the I/O circuitry 612 such that I/O circuitry 612 is capable of routing signals to and from the storage 614 to one or more other components of the processing system 600.

In association with executing an application, in one or more scenarios, the CPU 602 is configured to issue one or more instructions (e.g., threads) to be executed for an application to the AU 610. The AU 610 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 610 includes one or more compute units that concurrently execute one or more threads of an application and store data resulting from the execution of these threads in AU memory 634. This AU memory 634, for example, includes any combination of one or more volatile memories and/or non-volatile memories, examples of which include caches, video RAM (VRAM), or the like. In one or more implementations, these compute units are also configured to execute these threads based on the data stored in one or more physical registers 636 of the AU 610.

To facilitate communication between the AU 610 and one or more other components of processing system 600, the I/O circuitry 612 includes or is otherwise connected to one or more connectors, such as PCI connectors 638 (e.g., PCIe connectors) each including circuitry configured to communicatively couple the AU 610 to the I/O circuitry such that the I/O circuitry 612 is capable of routing signals to and from the AU 610 to one or more other components of the processing system 600. Further, the PCIe connectors 638 are configured to communicatively couple the I/O device 608 to the I/O circuitry 612 such that the I/O circuitry 612 is capable of routing signals to and from the I/O device 608 to one or more other components of the processing system 600.

By way of example and not limitation, the I/O device 608 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 608 is configured to execute one or more operations, tasks, instructions, or any combination thereof based on one or more physical registers 640 of the I/O device 608. In one or more implementations, such physical registers 640 are configured to maintain data (e.g., operands, instructions, values, variables) indicating one or more operations, tasks, or instructions to be performed by the I/O device 608.

To manage communication between components of the processing system 600 (e.g., AU 610, I/O device 608) that are connected to PCI connectors 638, and one or more other components of the processing system 600, the I/O circuitry 612 includes PCI switch 642. The PCI switch 642, for example, includes circuitry configured to route packets to and from the components of the processing system 600 connected to the PCI connectors 638 as well as to the other components of the processing system 600. As an example, based on address data indicated in a packet received from a first component (e.g., CPU 602), the PCI switch 642 routes the packet to a corresponding component (e.g., AU 610) connected to the PCI connectors 638.

Based on the processing system 600 executing a graphics application, for instance, the CPU 602, the AU 610, or both are configured to execute one or more instructions (e.g., draw calls) such that a scene including one or more graphics objects is rendered. After rendering such a scene, the processing system 600 stores the scene in the storage 614, displays the scene on the display 626, or both. The display 626, for example, includes a cathode-ray tube (CRT) display, liquid crystal display (LCD), light emitting diode (LED) display, organic light emitting diode (OLED) display, or any combination thereof. To enable the processing system 600 to display a scene on the display 626, the I/O circuitry 612 includes display circuitry 644. The display circuitry 644, for example, includes high-definition multimedia interface (HDMI) connectors, DisplayPort connectors, digital visual interface (DVI) connectors, USB connectors, and the like, each including circuitry configured to communicatively couple the display 626 to the I/O circuitry 612. Additionally or alternatively, the display circuitry 644 includes circuitry configured to manage the display of one or more scenes on the display 626 such as display controllers, buffers, memory, or any combination thereof.

Further, the CPU 602, the AU 610, or both are configured to concurrently run one or more virtual machines (VMs), which are each configured to execute one or more corresponding applications. To manage communications between such VMs and the underlying resources of the processing system 600, such as any one or more components of processing system 600, including the CPU 602, the I/O device 608, the AU 610, and the system memory 606, the I/O circuitry 612 includes memory management unit (MMU) 646 and input-output memory management unit (IOMMU) 648. The MMU 646 includes, for example, circuitry configured to manage memory requests, such as from the CPU 602 to the system memory 606. For example, the MMU 646 is configured to handle memory requests issued from the CPU 602 and associated with a VM running on the CPU 602. These memory requests, for example, request access to read, write, fetch, or pre-fetch data residing at one or more virtual addresses (e.g., guest virtual addresses) each indicating one or more portions (e.g., physical memory addresses) of the system memory 606. Based on receiving a memory request from the CPU 602, the MMU 646 is configured to translate the virtual address indicated in the memory request to a physical address in the system memory 606 and to fulfill the request. The IOMMU 648 includes, for example, circuitry configured to manage memory requests (memory-mapped I/O (MMIO) requests) from the CPU 602 to the I/O device 608, the AU 610, or both, and to manage memory requests (direct memory access (DMA) requests) from the I/O device 608 or the AU 610 to the system memory 606. For example, to access the registers 640 of the I/O device 608, the registers 636 of the AU 610, and/or the AU memory 634, the CPU 602 issues one or more MMIO requests. Such MMIO requests each request access to read, write, fetch, or pre-fetch data residing at one or more virtual addresses (e.g., guest virtual addresses) which each represent at least a portion of the registers 640 of the I/O device 608, the registers 636 of the AU 610, or the AU memory 634, respectively. As another example, to access the system memory 606 without using the CPU 602, the I/O device 608, the AU 610, or both are configured to issue one or more DMA requests. Such DMA requests each request access to read, write, fetch, or pre-fetch data residing at one or more virtual addresses (e.g., device virtual addresses) which each represent at least a portion of the system memory 606. Based on receiving an MMIO request or DMA request, the IOMMU 648 is configured to translate the virtual address indicated in the MMIO or DMA request to a physical address and fulfill the request.

In variations, the processing system 600 can include any combination of the components depicted and described. For example, in at least one variation, the processing system 600 does not include one or more of the components depicted and described in relation to FIG. 6. Additionally or alternatively, in at least one variation, the processing system 600 includes additional and/or different components from those depicted. The 600 is configurable in a variety of ways with different combinations of components in accordance with the described techniques.

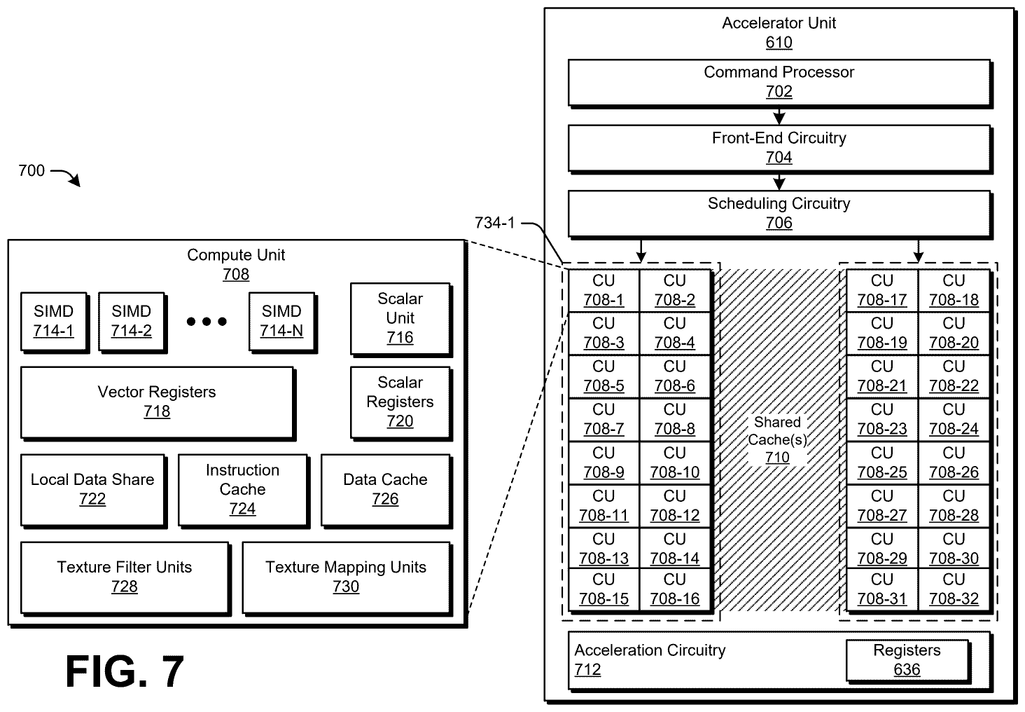

FIG. 7 depicts the AU 610, which is configured to execute workloads for one or more applications running on a processing system, such as the processing system 700. These applications include, for example, compute applications and/or graphics applications, each configured to issue respective series of instructions, also referred to herein as “threads,” to a central processing unit (e.g., the CPU 602) of the processing system. Compute applications, when executed by a processing system, cause the processing system to perform one or more computations, such as machine-learning, neural network, high-performance computing, or databasing computations.

Further, graphics applications, when executed by a processing system, cause the processing system to render a scene including one or more graphics objects and, as an example, output the scene on a display, such as the display 626. The instructions issued to the CPU from these applications, for example, include groups of threads, also referred to herein as “workgroups,” to be executed by AU 610. To perform these workgroups, the AU 610 includes one or more vector processors, coprocessors, graphics processing units (GPUs), general-purpose GPUs, non-scalar processors, highly parallel processors, artificial intelligence (AI) processors, inference engines, machine-learning processors, or any combination thereof. As an example, the AU 610 includes one or more command processors 702, front-end circuitry 704, scheduling circuitry 706, compute units 708, shared cache(s) 710, and acceleration circuitry 712.

A command processor 702 of AU 610 is configured to receive, from the CPU, a command stream indicating one or more workgroups to be executed. As an example, based on a compute application running on the processing system, the command processor 702 receives a command stream indicating workgroups that require compute operations such as matrix multiplication, addition, subtraction, and the like to be performed. As another example, based on a graphics application running on the processing system, the command processor 702 receives a command stream indicating workgroups that include draw calls for a scene to be rendered. After receiving a command stream, the command processor 702 parses the command stream and issues respective instructions of the indicated workgroups to the front-end circuitry 704, the scheduling circuitry 706, or both. As an example, based on a command stream from a graphics application, the command processor 702 issues one or more draw calls to the front-end circuitry 704. In one or more implementations, the front-end circuitry 704 includes one or more vertex shaders, polygon list builders, and so on.

Based on the instructions issued from the command processor 702, for instance, the front-end circuitry 704 is configured to position geometry objects in a scene, assemble primitives in a scene, cull primitives, perform visibility passes for primitives in a scene, generate visible primitive lists for a scene, or any combination thereof. In one example, based on a set of draw calls received from a command processor 702, the front-end circuitry 704 determines a list of primitives to be rendered for a scene. After determining a list of primitives to be rendered for the scene, the front-end circuitry 704 issues one or more draw calls (e.g., a workgroup) associated with the primitives in the list of primitives to the scheduling circuitry 706.

Based on the instructions of the workgroups received from a command processor 702, the front-end circuitry 704, or both, the scheduling circuitry 706 is configured to provide data indicating threads (e.g., operations for these threads) to be executed for these workgroups to one or more compute units 708.

In at least one implementation, each compute unit 708 is configured to support the concurrent execution of two or more threads of a workgroup. For example, each compute unit 708 is configured to concurrently execute a predetermined number of threads referred to herein as a “wavefront.” Based on the size of the wavefront of a compute unit 708, the scheduling circuitry 706 is configured to schedule one or more groups of threads of the workgroup, also referred to herein as “waves,” for execution by the compute unit 708.

As an example, the scheduling circuitry 706 first updates one or more registers of a compute unit 708 such that the compute unit 708 is configured to execute a first group of waves of the workgroup. After the compute unit 708 has executed the first group of waves, the scheduling circuitry 706 updates one or more registers of the compute unit 708 to schedule a second group of waves of the workgroup to be executed by the compute unit 708. To execute these waves, each compute unit is connected to one or more shared cache(s) 710. In one or more implementations, each of the shared cache(s) 710 includes a volatile memory, non-volatile memory, or both accessible by one or more of the compute units 708. These shared cache(s) 710, for example, are configured to store data (e.g., register files, values, operands, instructions, variables) used in the execution of one or more waves, data resulting from the performance of one or more waves, or both. Because a shared cache 710 is accessible by two or more compute units 708, a first compute unit 708 is capable of providing results from the execution of a first wave to a second compute unit 708 executing a second wave. Though the example presented in FIG. 7 shows AU 610 as including 32 compute units (708-1 to 708-32), in other implementations, the AU 610 can include any number of compute units 708, i.e., one or multiple compute units 708.

In the illustrated example, each compute unit 708 includes one or more single instruction, multiple data (SIMD) units 714, a scalar unit 716, one or more vector registers 718, one or more scalar registers 720, local data share 722, instruction cache 724, data cache 726, texture filter units 728, texture mapping units 730, or any combination thereof. In implementations, the compute unit 708 may be configured with different components than in the illustrated example. Additionally, in at least one variation, the AU 610 includes at least two different types of compute unit 708, such as a bank of a first compute unit type and a bank of a second compute unit type.

In one or more implementations, a SIMD unit 714 (e.g., a vector processor) is configured to concurrently perform multiple instances of the same operation for a wave. For example, a SIMD unit 714 includes two or more lanes each including an arithmetic logic unit (ALU) and each configured to perform the same operation(s) for the threads of a wave. Though the example embodiment presented in FIG. 7 shows a compute unit 708 including three SIMD units (714-1, 714-2, 714-N) representing an N number of SIMD units, in other implementations, a compute unit 708 can include any number of SIMD units 714, e.g., one or more SIMD units 714. Further, as an example, the size of a wavefront supported by the AU 610 is based on the number of SIMD units 714 included in each compute unit 708.

To determine the operations performed by the SIMD units 714, each compute unit 708 includes vector registers 718. In one or more implementations, the vector registers 718 are formed from one or more physical registers of the AU 610. These vector registers 718 are configured to store data (e.g., operands, values) used by the respective lanes of the SIMD units 714 to perform a corresponding operation for the wave. Additionally, each compute unit 708 includes a scalar unit 716 configured to perform scalar operations for the wave. As an example, the scalar unit 716 includes an ALU configured to perform scalar operations. To support the scalar unit 716, each compute unit 708 also includes scalar registers 720. In one or more implementations, the scalar registers are formed from one or more physical registers of the AU 610. These scalar registers 720 store data (e.g., operands, values) used by the scalar unit 716 to perform a corresponding scalar operation for the wave.

Further, each compute unit 708 includes a local data share 722. In one or more implementations, the local data share 722 is formed from a volatile memory (e.g., random-access memory) accessible by each SIMD unit 714 and the scalar unit 716 of the compute unit 708. That is to say, the local data share 722 is shared across each wave concurrently executing on the compute unit 708. The local data share 722 is configured to store data resulting from the execution of one or more operations for one or more waves, data (e.g., register files, values, operands, instructions, variables) used in the execution of one or operations for one or more waves, or both. As an example, the local data share 722 is used as a scratch memory to store results necessary for, aiding in, or helpful for the performance of one or more operations by one or more SIMD units 714.

The instruction cache 724 of a compute unit 708, for example, includes a volatile memory, non-volatile memory, or both configured to store the instructions to be executed for one or more waves executed by the compute unit 708. Further, the data cache 726 of a compute unit 708 includes a volatile memory, non-volatile memory, or both configured to store data (e.g., register files, values, operands, variables) used in the execution of one or more waves by the compute unit 708.

In at least one implementation, the instruction cache 724, the data cache 726, the shared cache(s) 710, and a system memory, for example, are arranged in a hierarchy based on the respective sizes of the caches. As an example, based on such a cache hierarchy, a compute unit 708 first requests data from a controller of a corresponding data cache 726. Based on the data not being in the data cache 726, the data cache 726 requests the data from a shared cache 710 at the next level of the cache hierarchy. The caches then continue in this way until the data is found in a cache or requested from the system memory, at which point, the data is returned to the compute unit 708.

Additionally, each compute unit 708 includes one or more texture mapping units 730 each including circuitry configured to map textures to one or more graphics objects (e.g., groups of primitives) generated by the compute units 708. Further, each compute unit 708 includes one or more texture filter units 728 each having circuitry configured to filter the textures applied to the generated graphics objects. For example, the texture filter units 728 are configured to perform one or more magnification operations, anti-aliasing operations, or both to filter a texture.

Additionally, to help perform instructions for one or more workgroups, AU 610 includes acceleration circuitry 712. Such acceleration circuitry 712 includes hardware (e.g., fixed-function hardware) configured to execute one or more instructions for one or more workgroups. As an example, the acceleration circuitry 712 includes one or more instances of fixed function hardware configured to encode frames, encode audio, decode frames, decode audio, display frames, output audio, perform matrix multiplication, or any combination thereof. To schedule instructions for execution on such hardware, the scheduling circuitry 706 is configured to update one or more physical registers 636 of the AU 610 associated with the hardware.

In some cases, the AU 610 includes one or more compute units 708 grouped into one or more shader engines 734 or engines for other types of computations, such as training and/or inference utilized to implement artificial intelligence. Referring to the embodiment depicted in FIG. 7, for example, the AU 610 includes compute units 708-1 to 708-16 grouped in a first shader engine 734-1 (or other type of engine) and compute units 708-17 to 708-32 grouped in a second shader engine 734-2 (or other type of engine). Such shader engines 734, for example, are configured to execute one or more workgroups (e.g., one or more compute kernels) for an application and include one or more compute units 708, graphics processing hardware (e.g., primitive assemblers, rasterizers), one or more shared cache(s) 710, render backends, or any combination thereof. Though the embodiment presented in FIG. 7 shows AU 610 as including two shader engines (734-1, 734-2), in other implementations, the AU 610 can include any number of shader engines (734-1, 734-2) or groupings for other types of operations.

What is claimed is:

1. A system comprising:
a host processor; and
a control processor communicatively coupled to an acceleration processor, the control processor configured to:
receive, from the host processor and via a management thread of the control processor, requests to execute multiple workloads of multiple applications on the acceleration processor;
create, by the management thread, task threads on the control processor allocated to corresponding applications and corresponding partitions of the acceleration processor;
receive, via the task threads, the multiple workloads from the host processor; and
dispatch, by the task threads, the multiple workloads to the corresponding partitions to be executed by the acceleration processor in parallel.

2. The system of claim 1, wherein to create the task threads, the control processor is configured to allocate, by the management thread, address spaces of control memory of the control processor to the corresponding applications.

3. The system of claim 2, wherein the control processor is configured to isolate, via the management thread and using memory isolation techniques, the address spaces in the control memory, thereby making data of the multiple applications inaccessible by other applications.

4. The system of claim 2, wherein to create a task thread for an application, the control processor is configured to open, via the management thread, a communication channel between the application and the task thread.

5. The system of claim 4, wherein to open the communication channel, the control processor is configured to communicate, via the management thread, a first address space of the control memory allocated to the task thread, the first address space being mapped to a second address space of interconnect memory accessible by the host processor.

6. The system of claim 5, wherein the communication channel includes interconnect circuitry that transports data written to the first address space by the control processor to the second address space, and transports data written to the second address space by the host processor to the first address space.

7. The system of claim 6, wherein the communication channel is a bi-directional communication channel in which the first address space includes a first write portion and a first read portion, the second address space includes a second write portion and a second read portion, the first read portion is connected via the interconnect circuitry to the second write portion, and the second read portion is connected via the interconnect circuitry to the first write portion.

8. The system of claim 7, wherein the bi-directional communication channel enables bi-directional, simultaneous communication of data between the control processor and the host processor.

9. The system of claim 1, wherein the acceleration processor is a neural processor configured to accelerate execution of machine learning workloads, and the multiple workloads include trained machine learning models and instructions for executing data, using the trained machine learning models, on the corresponding partitions of the neural processor.

10. The system of claim 1, wherein the control processor is further configured to communicate, via a task thread of an application, a completion signal to the host processor indicating that a workload has completed, the completion signal instructing the host processor to send an additional workload or send a closure signal to close the task thread.

11. A device comprising:
a control processor communicatively coupled to an acceleration processor; and
a host processor to:
communicate, to a management thread of the control processor, requests to execute multiple workloads of multiple applications on the acceleration processor;
receive indications of task threads of the control processor allocated to corresponding applications and corresponding partitions of the acceleration processor, the indications representing communication channels between the task threads and the corresponding applications; and
communicate, via the communication channels, the multiple workloads of the corresponding applications to the task threads to be forwarded to the corresponding partitions for parallel execution.

12. The device of claim 11, wherein to receive an indication of a task thread allocated to an application, the host processor is configured to:
receive a first address space of control memory of the control processor allocated to the task thread; and
allocate a second address space of interconnect memory accessible by the host processor to the application, the second address space being mapped to the first address space.

13. The device of claim 12, wherein a communication channel between the task thread and the application includes interconnect circuitry that transports data written to the first address space by the control processor to the second address space, and transports data written to the second address space by the host processor to the first address space.

14. The device of claim 13, wherein the communication channel is a bi-directional communication channel in which first address space includes a first write portion and first read portion, the second address space includes a second write portion and a second read portion, the first read portion is connected via the interconnect circuitry to the second write portion, and the second read portion is connected via the interconnect circuitry to the first write portion.

15. The device of claim 14, wherein the bi-directional communication channel enables bi-directional, simultaneous communication of data between the control processor and the host processor.

16. The device of claim 11, wherein the acceleration processor is a neural processor configured to accelerate execution of machine learning workloads, and the multiple workloads include trained machine learning models and instructions for executing data, using the trained machine learning models, on the corresponding partitions of the neural processor.

17. The device of claim 11, wherein the host processor is further configured to:
receive, from a task thread of an application, a completion signal indicating that a workload has completed; and
communicate, to the task thread and in response to the completion signal, an additional workload or a closure signal to close the task thread.

18. A method comprising:
receiving, by a management thread of a control processor, requests to execute multiple workloads of multiple applications on an acceleration processor;
creating, by the management thread, task threads on the control processor allocated to corresponding applications and corresponding partitions of the acceleration processor, the management thread and the task threads operating in isolated memory spaces; and
forwarding, by the task threads, workloads received from the corresponding applications to the corresponding partitions to be executed by the acceleration processor in parallel.

19. The method of claim 18, wherein creating the task threads includes:
allocating, by the management thread, address spaces of control memory of the control processor to the corresponding applications; and
isolating, by the management thread and using memory isolation techniques, the address spaces in the control memory, thereby making data of the multiple applications inaccessible by other applications.

20. The method of claim 18, wherein creating the task threads includes opening communication channels between the task threads and the corresponding applications, the communication channels including interconnect circuitry connecting first address spaces of the task threads to second address spaces accessible by the corresponding applications.
